(19) United States
(12) Patent Application Publication
(10) Pub. No.: US 2019/0107716 A1
(43) Pub. Date: Apr. 11, 2019

(54) HEAD-MOUNTED DISPLAY DEVICE, ELECTRONIC SYSTEM AND RELATED CONTROL METHOD

(71) Applicant: ACER INCORPORATED, New Taipei City (TW)

(72) Inventors: Yu-Chun Huang, New Taipei City (TW); Ruey-Ching Shyu, New Taipei City (TW)

(21) Appl. No.: 15/913,881

(22) Filed: Mar. 6, 2018

(30) Foreign Application Priority Data
Oct. 6, 2017 (TW) 106134456

(51) Int. Cl. G02B 27/01; G06F 3/01

(52) U.S. Cl. CPC G02B 27/017; G02B 27/0101; G02B 2027/0163; G06F 3/012; G02B 2027/014; G02B 27/0149

(57) ABSTRACT

A head-mounted display device includes a plurality of position tracking modules, each position tracking module generating a position detection signal; and a control unit for selecting a position tracking module from the plurality of position tracking modules according to a selection signal and establishing a connection between the control unit and the selected position tracking module for signal transmission.

### BACKGROUND OF THE INVENTION

### 1. Field of the Invention

The present invention relates to a head-mounted display device, an electronic system and related control method, and more particularly to a head-mounted display device, an electronic system and related control method capable of improving position tracking applicability.

### 2. Description of the Prior Art

A head-mounted display (HMD) is a type of display device, worn on the head, which displays image near the user's eyes. The user can wear the HMD displaying three-dimensional (3D) (or non-3D) images or other computer generated contents for virtual reality experience. However, virtual reality applications are increasing rapidly and demands for virtual reality devices continue to rise. Thus, there is a need for providing a more diversified application for HMD products.

### SUMMARY OF THE INVENTION

It is therefore an objective of the present invention to provide a head-mounted display device, an electronic system and related control method capable of improving position tracking applicability, to solve the problems in the prior art.

The present invention discloses a head-mounted display device, comprising: a plurality of position tracking modules, each position tracking module generating a position detection signal; and a control unit for selecting a position tracking module from the plurality of position tracking modules according to a selection signal and establishing a connection between the control unit and the selected position tracking module for signal transmission.

The present invention further discloses an electronic system, comprising: a selection unit, for generating a selection signal; and a head-mounted display device, comprising: a plurality of position tracking modules, each position tracking module generating a position detection signal; and a control unit for selecting a position tracking module from the plurality of position tracking modules according to the selection signal and establishing a connection between the control unit and the selected position tracking module for signal transmission; and a processing unit, for generating a display image according to the position detection signal generating by the selected position tracking module.

The present invention further discloses a control method, comprising: selecting a position tracking module from a plurality of position tracking modules according to a selection signal; and establishing a connection to the selected position tracking module for signal transmission.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of an electronic system according to an exemplary embodiment of the present invention.

FIG. 2 is a schematic diagram of the control unit shown in FIG. 1 according to an exemplary embodiment of the present invention.

### DETAILED DESCRIPTION

Certain terms are used throughout the description and following claims to refer to particular components. As one skilled in the art will appreciate, hardware manufacturers may refer to a component by different names. This document does not intend to distinguish between components that differ in name but not function.

In the following description and in the claims, the terms “include” and “comprise” are utilized in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

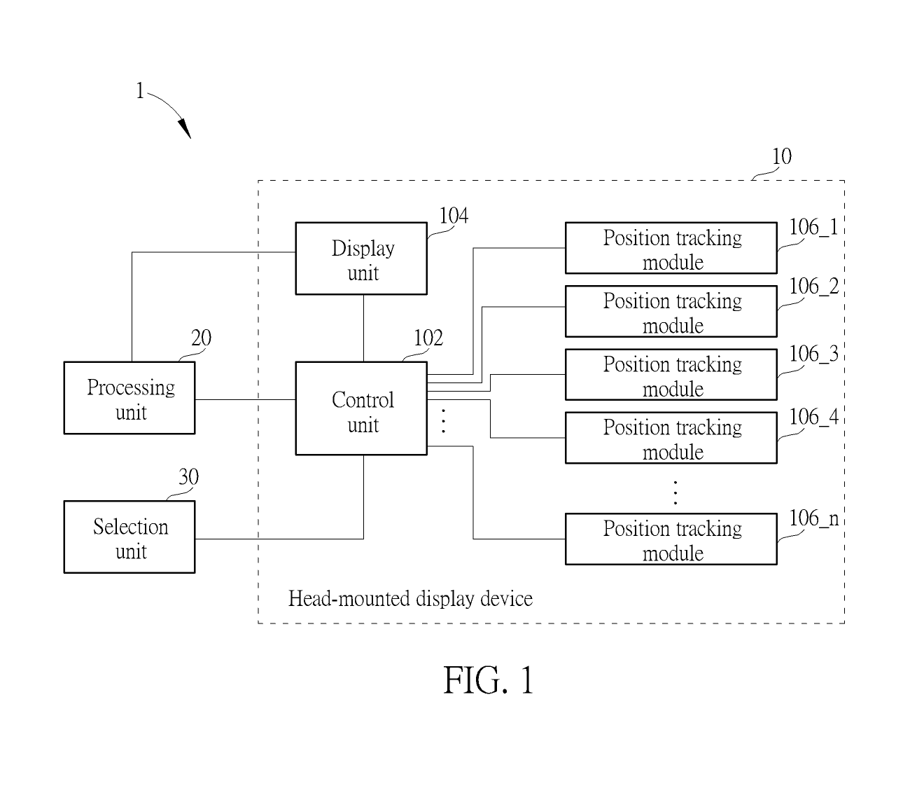

Please refer to FIG. 1, which is a schematic diagram of an electronic system 1 according to an exemplary embodiment of the present invention. The electronic system 1 may be applied in a virtual reality (VR) environment, an augmented reality (AR) environment or a mixed reality (MR) environment, and this should not be a limitation of the present invention. The electronic system 1 includes a head-mounted display device 10 and a processing unit 20. The head-mounted display device 10 includes a control unit 102, a display unit 104 and position tracking modules 106_1-106_n. Each position tracking module can be utilized for generating a corresponding position detection signal. The position tracking module includes an inside-out position tracking module, an outside-in position tracking module, or any combination thereof, and this should not be a limitation of the present invention.

The control unit 102 is utilized for selecting a position tracking module from the position tracking modules 106_1-106_n according to a selection signal and establishing a connection between the control unit 102 and the selected position tracking module for signal transmission. Therefore, the control unit 102 can communicate with the selected position tracking module. The control unit 102 can transmit signals to the selected position tracking module and receive related signals from the selected position tracking module. For example, the control unit 102 receives a position detection signal generating by the selected position tracking module. Further, the control unit 102 transmits the received position detection signal to the processing unit 20. The processing unit 20 determines a position or a posture of the head-mounted display device 10 according to the position detection signal and generates a display image that matches the current state according to the position or the posture of the head-mounted display device 10. The generated display image can be provided to the display unit 104 of the head-mounted display device 10 for display. In other words, via the control of the control unit 102, the head-mounted display device 10 can utilize different positioning tracking modules to detect and track the position of the head mounted display device 10 for display control according to the requirements.

After the connection between the control unit 102 and the selected position tracking module is established, the control unit 102 can communicate with the selected position tracking module via a transmission interface for signal transmission. For example, the transmission interface may be a universal serial bus (USB) interface, a serial peripheral interface (SPI), a camera serial interface (CSI), an inter-integrated circuit (I²C) interface, a universal asynchronous receiver/transmitter (UART) interface, a serial attached SCSI (SAS) interface, a RS-232 interface, or any other type of transmission interface.

In addition, after the control unit 102 selects a corresponding position tracking module according to the selection signal, the processing unit 20 transmits a control signal to the selected position tracking module so as to control or enable a position detection operation of the selected position tracking module.

The electronic system 1 further includes a selection unit 30 which is utilized for generating the selection signal. The selection result of the control unit 102 maybe determined by different selection signals. For example, if the position tracking module 106 1 is an inside-out position tracking module, the position tracking module 106 2 is an optical based outside-in position tracking module, and the position tracking module 106_3 is an acoustic based outside-in position tracking module. When the selection signal indicates utilizing an inside-out position tracking module, the control unit 102 selects the position tracking module 106_1 according to the selection signal. Further, the control unit 102 establishes a connection between the control unit 102 and the position tracking module 106_1, so that the control unit 102 can receive the position detection signal generated by the position tracking module 106_1. Moreover, the control unit 102 can provided the position detection signal to the processing unit 20 for the following operation. When the selection signal indicates utilizing an optical based outside-in position tracking module, the control unit 102 selects the position tracking module 106_2 according to the selection signal. Similarly, the control unit 102 establishes a connection between the control unit 102 and the position tracking module 106_2, so that the control unit 102 can receive the position detection signal generated by the position tracking module 106_2. Such like this, the control unit 102 can provided the position detection signal to the processing unit 20 for the following operation. Therefore, various position tracking modules can be integrated in a same electronic system. The head-mounted display device 10 can switch to utilize various position tracking modules to detect the position of the head-mounted display device 10 for meeting different use requirements.

The selection unit 30 can be implemented in hardware, firmware, software or any combination thereof. For example, the selection unit 30 can be a button, a switch, a touch panel, a touch pad, a keyboard, a mouse, a joystick, a trackball, or any device capable of generating a selection signal upon user's operation. In an embodiment, the selection unit 30 can be realized by an operating system or application software used in the electronic system 1. The user can utilize a user interface, a management interface or a menu of the operating system or the application software to select one of the position tracking modules 106_1-106_n for generating the corresponding selection signal. In another embodiment, the selection unit 30 can be realized by an operating system or application software used in the electronic system 1. The selection unit 30 can obtain related parameters of the operating system or the application software being executed on the electronic system 1, determine a to-be-selected position tracking module according to the obtained parameters, and generate a corresponding selection signal for indicating the to-be-selected position tracking module. For example, when virtual reality game software is executing on the electronic system 1, the selection unit 30 can read setting parameters from a program section of the virtual reality game software so as to generate the corresponding selection signal. If the setting parameter indicates utilizing the position tracking module 106_1, the selection unit 30 generate the corresponding selection signal for indicating utilizing the position tracking module 106_1. If the setting parameter indicates utilizing the position tracking module 106_3, the selection unit 30 generate the corresponding selection signal for indicating utilizing the position tracking module 106_3. In another embodiment, the selection unit 30 can be realized by an operating system or application software used in the electronic system 1. The selection unit 30 can detect a type of application software being executed on the electronic system 1. The selection unit 30 can query a lookup table according to the type of the application software being executed on the electronic system 1, so as to determine the position tracking module applicable for the application software and accordingly generate the corresponding selection signal. In addition, the selection unit 30 can receive commands generated by the processing unit 20 and accordingly generate the corresponding selection signal.

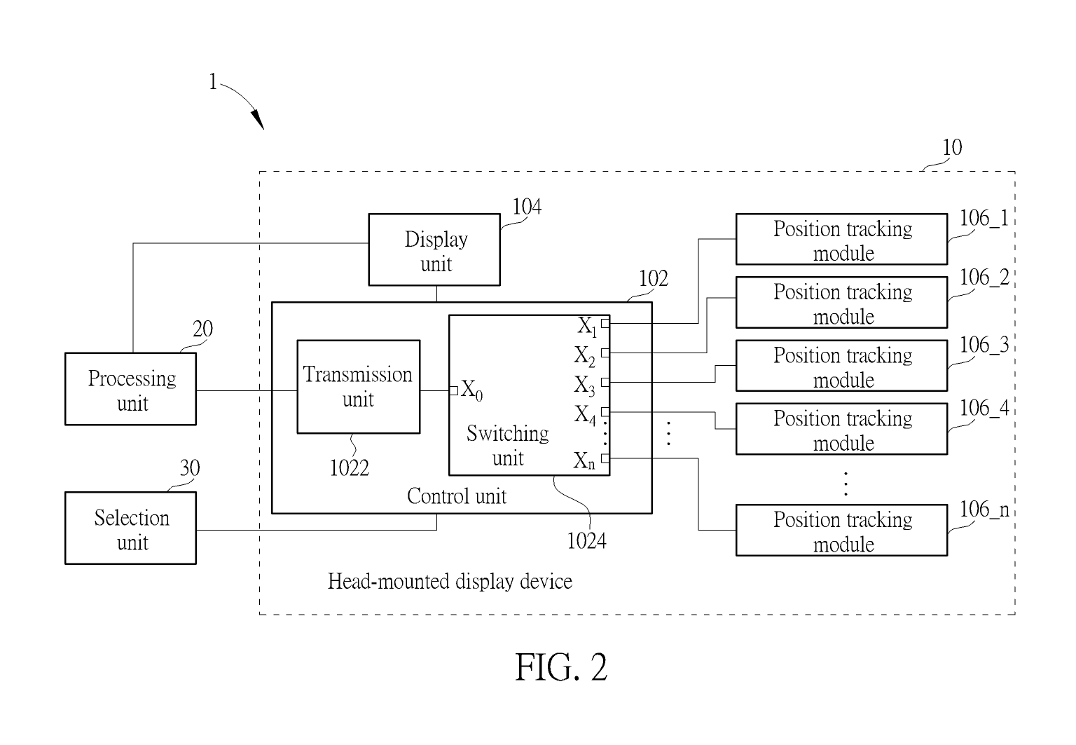

Please refer to FIG. 2, which is a schematic diagram of the control unit shown in FIG. 1 according to an exemplary embodiment of the present invention. As shown in FIG. 2, the control unit 102 includes a transmission unit 1022 and a switching unit 1024. The transmission unit 1022 is utilized for transmitting and receiving signals. The switching unit 1024 is coupled to the transmission unit 1022 for connecting the transmission unit 1022 to at least one of the position tracking modules 106_1-106_n. For example, the switching unit 1024 can select one position tracking module from the position tracking modules 106_1-106_n according to the selection signal and establish a connection between the switching unit 1024 and the selected position tracking module. Therefore, the transmission unit 1022 can transmit signals to the selected position tracking module via the switching unit 1024 and receive signals from the selected position tracking module via the switching unit 1024.

Moreover, the switching unit 1024 may be implemented in hardware. For example, the switching unit 1024 maybe a switch circuit, a multiplexer or other hardware device. The selection unit 30 may be implemented in firmware or software, and this should not be a limitation of the invention. For example, as shown in FIG. 2, the switching unit 1024 includes terminals X0-Xn. The terminal X0 is coupled to the transmission unit 1022. The terminals X1-Xn are connected to the position tracking modules 106_1-106_n respectively. The position tracking modules 106_1-106_n can be connected to the terminals X1-Xn, respectively, via wireless transmission interfaces or via wired transmission interfaces. For example, if the position tracking module 106_1 is an inside-out position tracking module, the position tracking module 106_2 is an optical based outside-in position tracking module, and the position tracking module 106_3 is an acoustic based outside-in position tracking module. When the selection signal indicates utilizing an inside-out position tracking module, the switching unit 1024 connects the terminal X0 to the terminal X1 according to the selection signal, so as to establish a connection between the terminal X0 and the terminal X1. As such, the transmission unit 1022 can receive the position detection signal generated by the position tracking module 106_1 via the switching unit 1024. Moreover, the transmission unit 1022 can provided related control signals to the position tracking module 106_1 via the switching unit 1024. In other words, the switching unit 1024 can establish the communication connection between the transmission unit 1022 and the position tracking module 106_1 in response to the indication of the selection signal. When the selection signal indicates utilizing an optical based outside-in position tracking module, the switching unit 1024 connects the terminal X0 to the terminal X2 according to the selection signal, so as to establish a connection between the terminal X0 and the terminal X2. As such, the transmission unit 1022 can receive the position detection signal generated by the position tracking module 106_2 via the switching unit 1024. Moreover, the transmission unit 1022 can provided related control signals to the position tracking module 106_2 via the switching unit 1024, and such like this. In brief, via the switching selection operation of the switching unit 1024, the head-mounted display device 10 can utilize different positioning tracking modules to detect and track the position of the head mounted display device 10 for display control according to the requirements.

Note that, the electronic system 1 is an exemplary embodiment of the invention, and those skilled in the art can make alterations and modifications accordingly. For example, the processing unit 20 can be integrated into the head-mounted display device 10. When receiving the position detection signal generating by the position tracking module, the control unit provides the received position detection signal to the processing unit 20. The processing unit 20 determines a position or a posture of the head-mounted display device 10 according to the position detection signal and generates a display image that matches the current state according to the position or the posture of the head-mounted display device 10. In addition, the selection unit 30 can also be integrated into the head-mounted display device 10. Each of the position tracking modules 106_1-106_n may be a part or the whole of a position tracking system. For example, each position tracking module may include at least one of a processor, a storage device, a sensor and any combination thereof.

In summary, since the conventional system only equips with a single fixed position tracking module, the user cannot choose an appropriate position tracking module according to the actual requirements, thus resulting in poor detection efficiency. In comparison, embodiments of the invention can utilize different positioning tracking modules to detect and track the position of the head mounted display device 10 for display control according to the requirements, so as to improve position tracking applicability and meet more diverse application requirements.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A head-mounted display device, comprising:
a plurality of position tracking modules, each position tracking module generating a position detection signal; and
a control unit for selecting a position tracking module from the plurality of position tracking modules according to a selection signal and establishing a connection between the control unit and the selected position tracking module for signal transmission.

2. The head-mounted display device of claim 1, wherein the control unit comprises:
a transmission unit for transmitting or receiving signals; and
a switching unit, coupled to the transmission unit, for connecting the transmission unit to the selected position tracking module according to the selection signal.

3. The head-mounted display device of claim 1, wherein each position tracking module comprises an inside-out position tracking module, an outside-in position tracking module, or combinations thereof.

4. The head-mounted display device of claim 1, further comprising:
a display unit for displaying a display image, wherein the display image is associated with the position detection signal generating by the selected position tracking module.

5. An electronic system, comprising:
a selection unit, for generating a selection signal; and
a head-mounted display device, comprising:
a plurality of position tracking modules, each position tracking module generating a position detection signal; and
a control unit for selecting a position tracking module from the plurality of position tracking modules according to the selection signal and establishing a connection between the control unit and the selected position tracking module for signal transmission; and
a processing unit, for generating a display image according to the position detection signal generating by the selected position tracking module.

6. The electronic system of claim 5, wherein the control unit comprises:
a transmission unit for transmitting and receiving signals; and
a switching unit, coupled to the transmission unit, for connecting the transmission unit to the selected position tracking module according to the selection signal.

7. The electronic system of claim 5, wherein each position tracking module comprises an inside-out position tracking module, an outside-in position tracking module, or combinations thereof.

8. The electronic system of claim 5, wherein the head-mounted display device further comprises:
a display unit for displaying the display image, wherein the display image is associated with the position detection signal generating by the selected position tracking module.

9. A control method, comprising:
selecting a position tracking module from a plurality of position tracking modules according to a selection signal; and
establishing a connection to the selected position tracking module for signal transmission.

10. The control method of claim 9, wherein each position tracking module comprises an inside-out position tracking module, an outside-in position tracking module, or combinations thereof.
